(19) United States
(12) Patent Application Publication
(10) Pub. No.: US 2011/0260352 A1
(43) Pub. Date: Oct. 27, 2011

(54) Stabilizing Semi-Crystalline Polymers To Improve Storage Performance Of Medical Devices

(76) Inventors: Fuh-Wei Tang, Temecula, CA (US); James Oberhauser, Saratoga, CA (US); Manish Gada, Santa Clara, CA (US); Lothar W. Kleiner, Los Altos, CA (US); Vincent J. Gueriguian, San Francisco, CA (US)

(21) Appl. No.: 12/764,803

(22) Filed: Apr. 21, 2010

(51) Int. Cl. B29C 44/20

(52) U.S. Cl. 264/51

(57) ABSTRACT

Methods are disclosed for improving the storage performance of polymeric stents that reduce or eliminate the effects of long term aging on the properties of the stents. A polymeric stent or a polymeric tube from which a stent is made is heated to a temperature between ambient and the glass transition temperature of the polymer for a period of time. The heating causes densification or an increase in density of the polymer which stabilizes the properties of the polymer in later processing steps and storage. The stent can be made from a polymeric tube that is expanded at a temperature above the glass transition temperature and cooled to maintain an expanded diameter.

### BACKGROUND OF THE INVENTION

1. Field of the Invention

This invention relates to methods making stents from bioabsorbable polymers.

2. Description of the State of the Art

This invention relates to radially expandable endoprostheses that are adapted to be implanted in a bodily lumen. An “endoprosthesis” corresponds to an artificial device that is placed inside the body. A “lumen” refers to a cavity of a tubular organ such as a blood vessel. A stent is an example of such an endoprosthesis. Stents are generally cylindrically shaped devices that function to hold open and sometimes expand a segment of a blood vessel or other anatomical lumen such as urinary tracts and bile ducts. Stents are often used in the treatment of atherosclerotic stenosis in blood vessels. “Stenosis” refers to a narrowing or constriction of a bodily passage or orifice. In such treatments, stents reinforce body vessels and prevent restenosis following angioplasty in the vascular system. “Restenosis” refers to the reoccurrence of stenosis in a blood vessel or heart valve after it has been treated (as by balloon angioplasty, stenting, or valvuloplasty) with apparent success.

Stents are typically composed of scaffolding that includes a pattern or network of interconnecting structural elements or struts, formed from wires, tubes, or sheets of material rolled into a cylindrical shape. This scaffolding gets its name because it physically holds open and, if desired, expands the wall of the passageway. Typically, stents are capable of being compressed or crimped onto a catheter so that they can be delivered to and deployed at a treatment site. Delivery includes inserting the stent through small lumens using a catheter and transporting it to the treatment site. Deployment includes expanding the stent to a larger diameter once it is at the desired location. Mechanical intervention with stents has reduced the rate of restenosis as compared to balloon angioplasty. Yet, restenosis remains a significant problem. When restenosis does occur in the stented segment, its treatment can be challenging, as clinical options are more limited than for those lesions that were treated solely with a balloon.

Stents are used not only for mechanical intervention but also as vehicles for providing biological therapy. Biological therapy uses medicated stents to locally administer a therapeutic substance. A medicated stent may be fabricated by coating the surface of either a metallic or polymeric scaffolding with a polymeric carrier that includes an active or bioactive agent or drug. Polymeric scaffolding may also serve as a carrier of an active agent or drug.

Furthermore, it may be desirable for a stent to be biodegradable. In many treatment applications, the presence of a stent in a body may be necessary for a limited period of time until its intended function of, for example, maintaining vascular patency and/or drug delivery is accomplished. Therefore, stents fabricated from biodegradable, bioabsorbable, and/or bioerodable materials such as bioabsorbable polymers should be configured to completely erode only after the clinical need for them has ended.

However, one of the challenges of making medical devices out of polymers is that polymers are subject to physical aging. Medical devices are typically storage for an indefinite period of time after fabrication. During storage physical aging causes the physical properties of the polymer to change as a function of time. Since storage time will vary for each device that is made, the problem of product consistency arises.

### SUMMARY OF THE INVENTION

Various embodiments of the present invention A method for reducing long term aging of stent, comprising: providing a polymeric tube, the polymer having a Tg above ambient temperature; radially expanding the tube at a temperature above the Tg of the polymer; cooling the expanded tube to a temperature below the Tg of the polymer which maintains the tube at an expanded diameter; and heating the expanded tube to a temperature range between room temperature and the Tg of the polymer and maintaining the temperature range for a treatment time, wherein the increase in temperature increases the density of the polymer; cooling the tube after the treatment time to ambient temperature; and making a stent from the cooled tube.

Further embodiments of the present invention include a method of making a stent, comprising: radially expanding a polymeric tube at a temperature above the Tg of the polymer, the polymer having a Tg above room temperature; cooling the expanded tube to a temperature below the Tg of the polymer which maintains the tube at an expanded diameter; making a stent body from the cooled, expanded tube; heating the stent body to a temperature range between ambient temperature and the Tg of the polymer before coating, crimping, or sterilizing the stent body, maintaining the temperature range for a treatment time, wherein the increase in temperature increases the density of the polymeric stent body; and cooling the stent body to ambient temperature.

Additional embodiments of the present invention include a method reducing long term aging of stent, comprising: heating a polymeric stent body or polymeric tube to a temperature range between ambient temperature and a Tg of the polymer, wherein the Tg of the polymer is greater than room temperature; cooling the stent body or polymeric tube to at most the ambient temperature; repeating the heating and cooling steps at least one time; and if a polymeric tube, making a stent body from the polymeric tube.

### BRIEF DESCRIPTION OF THE DRAWINGS

FIG. 1 depicts a three-dimensional view of a cylindrically-shaped stent.

FIGS. 2-3 depict a radial expansion process of a polymer tube.

FIGS. 4A and 4B depict a radial cross-section and an axial cross-section of a tube, respectively.

FIGS. 5A and 5B depict a tube loosely fitted over a tubular mandrel.

FIGS. 6A and 6B depict a tube tightly fitted over a tubular mandrel.

### DETAILED DESCRIPTION OF THE INVENTION

Embodiments of the present invention relate to treating implantable medical devices such as stents or constructs that are precursors to such devices, such as tubes, to reduce or eliminate the effects of physical aging that occurs during storage of devices. More generally, embodiments of the present invention may also be used on devices or precursors thereof including, but not limited to, self-expandable stents, balloon-expandable stents, stent-grafts, vascular grafts, cerebrospinal fluid shunts, or generally tubular implantable medical devices.

In particular, a stent can have virtually any structural pattern that is compatible with a bodily lumen in which it is implanted. Typically, a stent is composed of a pattern or network of circumferential and longitudinally extending interconnecting structural elements or struts. In general, the struts are arranged in patterns, which are designed to contact the lumen walls of a vessel and to maintain vascular patency. A myriad of strut patterns are known in the art for achieving particular design goals. A few of the more important design characteristics of stents are radial or hoop strength, expansion ratio, coverage area, and longitudinal flexibility. Embodiments of the present invention are applicable to virtually any stent design and are, therefore, not limited to any particular stent design or pattern. One embodiment of a stent pattern may include cylindrical rings composed of struts. The cylindrical rings may be connected by connecting struts.

In some embodiments, a stent may be formed from a tube by laser cutting the pattern of struts in the tube. Such tubes are typically formed by the melt processing methods of extrusion or injection molding. The stent may also be formed by laser cutting a metallic or polymeric sheet, rolling the pattern into the shape of the cylindrical stent, and providing a longitudinal weld to form the stent. Other methods of forming stents are well known and include chemically etching a metallic or polymeric sheet and rolling and then welding it to form the stent.

In other embodiments, a metallic or polymeric filament or wire may also be coiled to form the stent. Filaments of polymer may be extruded, melt spun, solution spun or, eletrospun. These filaments can then be cut, formed into ring elements, welded closed, corrugated to form crowns, and then the crowns welded together by heat or solvent to form the stent.

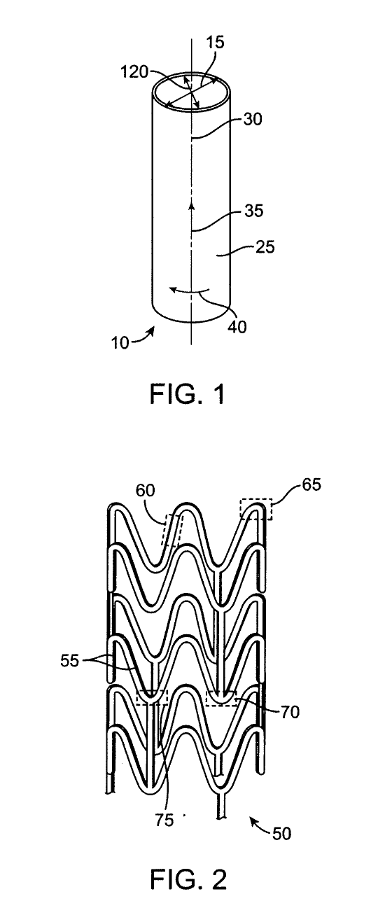

FIG. 1 depicts a tube 10 which is a cylinder with an outside diameter 15 and an inside diameter 20. FIG. 1 also depicts a surface 25 and a cylindrical axis 30 of tube 10. In some embodiments, the diameter of the polymer tube prior to fabrication of an implantable medical device may be between about 0.2 mm and about 5.0 mm, or more narrowly between about 1 mm and about 4 mm.

FIG. 2 depicts an example of a stent 50. Stent 50 includes a pattern with a plurality of interconnecting structural elements or struts 55. The embodiments disclosed herein are not limited to stents or to the stent pattern illustrated in FIG. 2. The embodiments are easily applicable to other patterns and other devices. The variations in the structure of patterns are virtually unlimited.

In general, a stent pattern is designed so that the stent can be radially compressed (crimped) and radially expanded (to allow deployment). The stresses involved during compression and expansion are generally distributed throughout various structural elements of the stent pattern. As a stent expands, various portions of the stent can deform to accomplish a radial compression or expansion.

As shown in FIG. 2, the geometry or shape of stent 50 varies throughout its structure to allow radial expansion and compression. A pattern may include portions of struts that are straight or relatively straight, an example being a portion 60. In addition, patterns may include struts that include curved or bent portions or crowns denoted as 65, 70, and 75.

The pattern that makes up the stent allows the stent to be radially compressible and expandable and longitudinally flexible. Portions such as sections 65, 70, and 75 of the stent pattern are subjected to substantial deformation as these portions bend during radial expansion and compression. Thus, these portions tend to be the most vulnerable to failure.

The cross-section of the struts in stent may be rectangular- or circular-shaped. The cross-section of struts is not limited to these, and therefore, other cross-sectional shapes are applicable with embodiments of the present invention. Furthermore, the pattern should not be limited to what has been illustrated as other stent patterns are easily applicable with embodiments of the present invention.

The struts of the stent scaffolding can be made partially or completely from a biodegradable, bioabsorbable, bioresorbable, or biostable polymer. In this case, a scaffolding composed of a polymer or primarily of a polymer provides support or outward radial force to a vessel wall when implanted. A polymer for use in fabricating a stent can be biostable, bioabsorbable, biodegradable, bioresorbable, or bioerodable. Biostable refers to polymers that are not biodegradable. The terms biodegradable, bioabsorbable, bioresorbable, and bioerodable are used interchangeably and refer to polymers that are capable of being completely degraded and/or eroded when exposed to bodily fluids such as blood and can be gradually resorbed, absorbed, and/or eliminated by the body. The processes of breaking down and absorption of the polymer can be caused by, for example, hydrolysis and metabolic processes.

The tube or stent body or scaffolding of the present invention can be made in whole or in part from one or a combination of biodegradable polymers including, but not limited to, poly(L-lactide) (PLLA), polymandelide (PM), poly(DL-lactide) (PDLLA), polyglycolide (PGA), and poly(L-lactide-co-glycode). The tube or stent can be made of a random, alternating, or block copolymer of the above polymers and one or more of the following: polycaprolactone (PCL), poly(trimethylene carbonate) (PTMC), polydioxanone (PDO), poly(4-hydroxy butyrate) (PHB), and poly(butylene succinate) (PBS). The PLGA used can include any molar ratio of L-lactide (LLA) to glycolide (GA). In particular, the stent can be made from PLGA with a molar ratio of (LA:GA) including 85:15 (or a range of 82:18 to 88:12), 95:5 (or a range of 93:7 to 97:3), or commercially available PLGA products identified as having these molar ratios.

TABLE 1
Glass transition temperatures of polymers.

| | Glass-Transition |
|---|---|
| Polymer | Temp (° C.)¹ |
| PGA | 35-40 |
| PLLA | 60-65 |
| PDLLA | 55-60 |
| 85/15 PLGA | 50-55 |
| 75/25 PLGA | 50-55 |
| 65/35 PLGA | 45-50 |
| 50/50 PLGA | 45-50 |

¹Medical Plastics and Biomaterials Magazine, March 1998.

An exemplary embodiment is a PLLA scaffolding with a coating including PDLLA and everolimus.

Polymers that may be used for struts of a bioabsorbable stent include semi-crystalline biodegradable polymers, such as, biodegradable polyesters. In particular, struts can be made mostly or completely out of biodegradable polyesters having a glass transition temperature (Tg) above body temperature, which is about 37° C. For example, this includes PLLA and PLGA.

Following fabrication of a device, the device typically is stored for an indefinite period of time prior to use in a patient. The storage period can be days, weeks, or months and is typically not the same for every individual device. Polymers, particularly polymers that are at least partially amorphous such as semicrystalline polymers, generally undergo physical aging during storage when the glass transition, Tg, of the amorphous region is greater than the storage temperature. Physical aging corresponds to densification or a volumetric shrinkage of the amorphous regions of a polymer. The densification causes a change in material properties of the polymer with time. For semicrystalline polymers, the densification occurs in the amorphous regions of the polymer.

The densification process can occur below the glass transition temperature of a polymer, which for many commercially useful polymers is at typical storage temperatures. Normal storage temperature, which, for the purposes of this invention is room or ambient temperature, i.e., from about 15° C. to about 35° C., or more narrowly, from about 20° C. to about 30° C. The ambient temperature can be any temperature within these ranges. In extreme transportation conditions, the storage temperature may approach 40° C. or more.

The amount of densification that can occur during storage is enhanced when the polymer chains are in a non-equilibrium condition. The non-equilibrium condition in the polymer can be due to excess free volume. The free volume of a polymer is the volume of the polymer not actually occupied by the polymer molecules themselves. When an amorphous material is cooled rapidly below its Tg, it typically leads to such a non-equilibrium condition in the polymer on the microscopic level due to the presence of excess free volume. The mobility of the molecules with excess free volume within the glassy state (state below Tg) will cause the system to relax and densify over time.

The free volume of the polymer can be manipulated by modifying the conditions on which densification depends. The physical aging process rate depends on factors such as the molecular weight of the polymer, the extent of amorphous molecules available, and the aging temperature relative to the Tg of the polymer.

As indicated above, densification occurs when an amorphous or semi-crystalline polymer is cooled at a non-equilibrium rate from a temperature above its Tg to a temperature below its Tg. Non-equilibrium cooling is normally what will occur in most industrial settings since equilibrium cooling is very slow and would be considered economically impractical. The non-equilibrium cooling rate results in the polymer chains of the amorphous domains being trapped at non-optimal separation distances, creating excess free volume, in the glassy state that forms when the temperature goes below Tg. The chains then attempt to achieve optimal separation by coordinated localized chain motion, resulting in a decrease in specific volume. The reordering of polymer chains tends to increase the modulus of the polymer resulting in a brittle or more brittle polymer. Thus, densification of a polymer initially selected for its toughness and elasticity may make the coating or polymeric scaffolding more susceptible to failure when the polymer ages or densifies and becomes more brittle.

Polymers in such a non-equilibrium condition can have residual stresses that will be relieved as the polymer densifies. As used herein, a “residual stress” includes, without limitation, the stress in a bulk polymer that is in a non-equilibrium thermodynamic state.

Perhaps of even more consequence than the actual change in properties of a given device is that inconsistency of the change in properties between different devices. The degree of densification depends on the storage temperature history and the storage time. Therefore, devices with different temperature histories, storage times, or both can have inconsistent properties. Such inconsistent properties can lead to different performance of the device upon implantation in a patient.

The processing history of a polymer stent can result in physical aging during storage. A manufacturing process of a polymeric stent can include, but is not limited to, obtaining a polymeric tube formed by a melt processing method, such as extrusion or injection molding. As indicated above, such processing methods inherently involve cooling at a non-equilibrium rate that results in excess free volume which leads to densification during storage.

The manufacturing process further includes radially expanding the tube to an expanded diameter and cutting a stent pattern in the expanded tube. Prior to expansion, the tube may be completely amorphous or have a relatively low crystallinity, for example, less than 20%, less than 10%, or less than 5%. The tube at both the initial and expanded diameter have wall thicknesses that are large enough that they can support an outward radial force or load. This is in contrast to a tubular membrane structure, such as a balloon, that has a wall thickness that is so thin that the tubular membrane cannot support a load at a given diameter unless it is preloaded, i.e., inflated with a fluid, such as a gas.

An extruded polymer tube for use in manufacturing a stent can have an outside diameter of 2-4 mm. However, the present invention is also applicable to polymer tubes with outside diameters less than 1 mm or greater than 4 mm. The wall thickness of the polymer tube can be 0.05-3 mm, however, the present invention is application to tubes with a wall thickness less than 0.05 mm and greater than 3 mm.

The tube can also be axially elongated or extended as well during the expansion process. The tube is radially expanded to increase its radial strength, which can also increase the radial strength of the stent. The radial expansion process tends to preferentially align the polymer chains along the radial or hoop direction which is results in enhanced radial strength. The radial expansion step is crucial to making a stent scaffolding with thin struts that is sufficiently strong to support a lumen upon implantation.

The tube is radially expanded by heating the tube to a temperature between Tg and the melting point of the polymer. Upon expansion the tube is cooled to below the Tg of the polymer, typically to ambient temperature, to maintain the tube at an expanded diameter. Since the tube is expanded and then cooled at a non-equilibrium rate which then maintains the tube at an expanded diameter, the polymer of the expanded tube is believed to be additionally made susceptible to densification. The percent radial expansion may be between 200 and 500%. The percent radial expansion is defined as RE %=(RE ratio−1)×100%, where the RE Ratio=(Inside Diameter of Expanded Tube)/(Original Inside Diameter of the tube).

The percent of axial extension that the polymer tube undergoes is defined as AE %=(AE ratio−1)×100%, where the AE Ratio=(Length of Extended Tube)/(Original Length of the Tube).

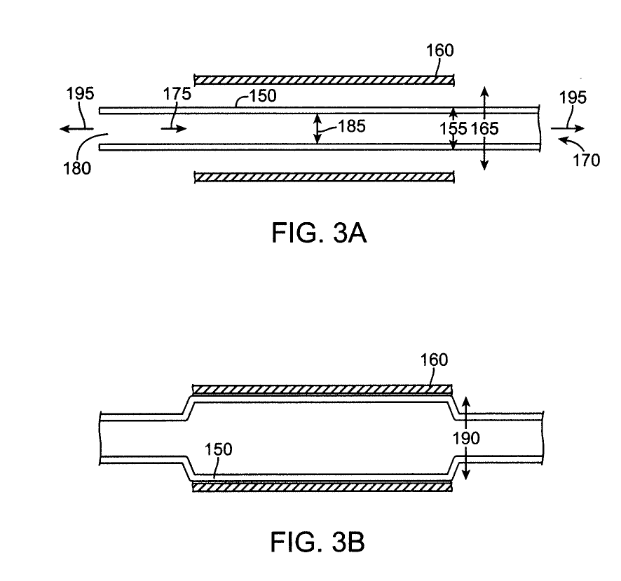

FIGS. 2 and 3 illustrate an embodiment of radial expanded (and axial extending) a polymer tube for use in manufacturing an implantable medical device, such as a stent. FIG. 2 depicts an axial cross-section of a polymer tube 150 with an outside diameter 155 positioned within an annular member or mold 160. Mold 160 limits the radial expansion of polymer tube 150 to a diameter 165, the inside diameter of mold 160. Polymer tube 150 may be closed at a distal end 170. Distal end 170 may be open in subsequent manufacturing steps. A gas may be conveyed, as indicated by an arrow 175, into an open proximal end 180 of polymer tube 150. A tensile force 195 is applied at proximal end 180 and a distal end 170.

Polymer tube 150 may be heated by heating the gas to a temperature above ambient temperature prior to conveying the gas into polymer tube 150. Alternatively, the polymer tube may be heated by heating the exterior of mold 160. For example, the mold exterior can be heated with a nozzle that blows a warm gas onto the mold exterior. The increase in pressure inside of polymer tube 150, facilitated by an increase in temperature of the polymer tube, causes radial deformation of polymer tube 150, as indicated by an arrow 185. FIG. 3 depicts polymer tube 150 in an expanded state with an outside diameter 190 within annular member 160.

A stent pattern is cut into the expanded tube, for example, by laser machining The expansion of the tube decreases the wall thickness of the tube. The width and thickness of the stent can be, for example, between 140-160 microns.

After cutting a stent pattern into the expanded tube, the stent scaffolding may then be optionally coated with a drug delivery coating which can include a polymer and a drug. In order to make the stent ready for delivery, the stent is secured to a delivery balloon. In this process, the stent is compressed to a reduced diameter or crimped over the balloon. During crimping and in the crimped state, the crowns of the stent are subjected to high, localized stress and strain. In particular, the inside or concave region of the crowns is subjected to high compressive stress and strain. Thus, the stent during crimping and in the crimped state is susceptible to cracking. It is important to minimize cracking in this state, since this can have an negative impact on the ability of the stent must to support a vessel upon deployment.

Due to the high stress and strain the stent is subjected to during crimping and deployment, it is important for the stent body to have high fracture toughness to inhibit cracking Fracture toughness is enhanced for a semi-crystalline polymer minimizing the size of crystalline domains and achieving an optimal amorphous/crystalline ratio. The crystallinity provides strength and stiffness (high modulus) to the polymer which is needed for supporting a vessel. However, if the degree of crystallinity is too high, the polymer may be too brittle and is more susceptible to fracture. The degree of crystallinity for a PLLA scaffolding should be 10-40%, or more narrowly, 30-40%.

Since crystals nucleate and grow between Tg and the melting temperature of a semi-crystalline polymer, the size of crystalline domains and degree of crystallinity depend on process parameters of the radial expansion process, such as the expansion temperature, heating rate, and time spent above Tg. Generally, smaller crystals are favored or generated at lower temperatures closer to Tg than the melting temperature. For example, for a PLLA tube, an expansion temperature of 65-120° C. is preferred.

In general, it is crucial to inhibit loss of properties generated by the radial expansion in later pressing steps and after manufacture during a storage period all the way to the deployment of the stent in a patient. These properties include alignment of polymer chains, the small crystalline domains, and the degree of crystallinity. Exposure of the stent to temperatures above Tg will modify these properties and could negatively impact the performance of the stent when implanted.

The stent is deployed by expanding it to an increased diameter at an implant site in a vessel which can be greater than the as-cut diameter of the stent. The deployed stent must have sufficient radial strength to apply an outward radial force to support the vessel at an increased diameter for a period of time. The crown regions of the deployed stent are under high stress and strain during expansion and after deployment.

Therefore, the critical challenges of polymeric stent design include maintaining a desired radial strength and having minimal cracking before bioabsorbable degradation starts after the implantation. The radial strength, crack resistance, and other key mechanical properties of polymeric stent and tubing are controlled and determined by the ratio of amorphous/crystal domains, size of crystalline domains, and level of densification in the amorphous area in the polymeric tubing and the stent. The safety and efficacy of bioabsorbable stents are strongly dependent on mechanical properties such as radial strength, recoil, and crack resistance.

Various embodiments of the present invention include treating an expanded polymer tube as a stent precursor or polymeric stent body to stabilize the polymer. A polymer tube for use in making a stent will be referred to as a stent precursor. An expanded polymer tube can refer to an extruded or injection molded polymer tube that has been radially expanded to a larger diameter and has the larger diameter.

The stent body can be a scaffolding including a plurality of struts that is made from an expanded tube. The treatment accelerates the densification of the polymer of the precursor which results in a decrease in excess free volume and residual stresses prior to later processing steps and storage. The stabilizing process accelerates densification during the time period of the treatment. This treatment period (minutes to hours) is much shorter than a typical storage time (days, weeks, or months). The treatment dramatically reduces the amount of densification that can occur during storage due to the accelerated densification during the treatment period.

The stabilization of the polymer may be important in maintaining properties in later processing steps such as laser cutting, spray coating, and crimping. In laser cutting, a small region near the cut surface is subjected to heat from the laser which could result in selective changes in properties in this region. With a stabilized polymer, such very little further changes would occur. In a spray coating process, the stent is subjected to heat to remove solvent from a coating material applied to the stent that includes polymer and solvent. Such heating also could result in densification of the stent body. Again, in a stabilized polymer, very little further densification would occur. As indicated above, during crimping and in the crimped state, the crowns or bending regions of the stent are subjected to high, localized stress and strain. As the polymer ages in this stressed state, it can densify and become brittle which makes it more susceptible to cracking A polymer that has been stabilized prior to crimping will undergo significantly less change in properties during storage in the crimped state and be less susceptible to cracking in this stressed state.

Through use of a stabilizing process obtained by means of temperature and time control, a densified highly amorphous polymer, such as PLLA, can be obtained. For example, the highly amorphous polymer can be 100% amorphous, less than 5% amorphous, 5-20% amorphous, 20-35% amorphous, 35-45% amorphous, or 45-55% amorphous. A highly amorphous polymer also be characterized as less than 60%, 50%, 40%, 30%, or less than 20% crystallinity. A densified high amorphous polymer such as PLLA will improve stability by preventing significant additional physical aging while still maintaining a high modulus or having a slightly higher modulus (e.g., 1-5% higher modulus) due to the crystalline portion of the polymer. The treatment will improve shelf life as additional physical aging will be significantly reduced. As a result, product consistency will be greatly improved.

In certain embodiments, the stabilizing treatment includes exposing the polymer of the stent body or tube to a treatment temperature or within a range of treatment temperatures between ambient temperature and the Tg of the polymer. In such embodiments, the temperature of the polymer is heated to the temperature or within the temperature range. The polymer is treated at the treatment temperature or temperature range for a treatment time sufficient to obtain a desired amount of accelerated densification. The treatment temperature can be just below Tg, for example, Tg−5° C. to Tg−1° C., or more narrowly, Tg−5° C. to Tg−2° C.

At the end of the treatment time, the stent body or tube is cooled below the treatment temperature. In one embodiment, the stent body or tube can be cooled to ambient temperature. Additionally, or alternatively, the stent body or tube can be cooled to a temperature below ambient temperature, for example, to less than 15° C., less than 5° C., or less than 15° C. The stent body or tube can be cooled to 15-20° C., 10-15° C., or 0-10° C.

The degree of densification achieved during treatment depends primarily on the treatment temperature and treatment time. The higher the treatment temperature, the shorter the treatment time that is required for a desired degree of densification. In exemplary embodiments, the treatment time can be between 3 min to 24 hours, or more narrowly, 3 min-1 hr, 1-2 hr, 2-4 hr, 4-8 hr, 8-12 hr, 12-18 hr, or 18-24 hr. The Tg for PLLA has been reported between 60 and 65° C. (See Table 1). Thus, for PLLA, the treatment temperature can be between 35° C. and 55° C., or more narrowly, 35-38° C., 38-42° C., 42-46° C., 46-50° C., and 50-55° C. The treatment temperature can also be above 55° C. to just below the Tg of PLLA.

In certain embodiments, the polymer tube has been subjected to a radial expansion process described above to increase radial strength and generate the desirable microstructure including a small crystal size, degree of crystallinity, and radial or hoop polymer chain alignment. The stent body may correspond to a scaffolding cut from a such a tube. In some embodiments, the stabilizing treatment can be performed on the tube after it is expanded and cooled. Additionally or alternatively, the stabilizing treatment can be performed on the stent body after laser cutting a pattern in the tube.

It is important for the treatment temperature to be below the Tg of the polymer so that the treatment does not adversely modify the microstructure and mechanical properties of the polymer generated during the radial expansion, including small crystal size, degree of crystallinity, and radial alignment of polymer chains. Treating the polymer at a temperature above Tg and below Tm will result in changes in the crystallinity, crystal size, and alignment of polymer chains. Therefore, treatment above Tg may also result in undesirable changes in microstructure. Such changes include an increase in crystal size and degree of crystallinity and loss of radial alignment.

In some embodiments, the stent or perform is subjected to a single step including heating to a treatment temperature or temperature range, maintaining the stent or tube at the treatment temperature or range for a treatment time, and cooling. In further embodiments, the treatment of the stent or tube can include cycling the temperature, i.e., increasing the temperature, lowering the temperature, repeating one or more times. In such embodiments, the stent or tube is heated to the treatment temperature, cooled, followed by a repeating the heating and cooling one or more times. When the stent or tube is heated to the treatment temperature or range, the temperature can be maintained for a period of time. Alternatively, rather than maintaining the stent or tube at the treatment temperature, cooling can start as soon as the treatment temperature is reached. In such cycling, the stent or tube can be cooled to a temperature below ambient, as mentioned above.

In exemplary embodiments, the stent or tube can be subjected to two, three, four, or more than four or more cycles. The stent or tube can be cycled between sub-ambient and the treatment temperature less the Tg of the polymer. The subambient range can be less than 20° C., less than 10° C., or more narrowly, 5-10° C. In the case of a PLLA stent or tube, the cycling can be between a temperature in the subambient ranges disclosed above and any temperature between 35-55° C. Such ranges can apply to stent body made of 100% PLLA or mostly PLLA or PLLA-based polymer, for example, greater than 90 wt % or mol % PLLA.

The cycling can be performed by first exposing the stent or tube to the treatment temperature by methods described below (e.g., blowing warm air, placing in temperature controlled oven) for a period of time. Then the heated stent or tube is exposed to a reduced temperature (e.g., ambient or subambient).

In the temperature cycling embodiments, the time of exposure to the treatment temperature can be less than 1 hr or less than 30 min, and more narrowly, 3-20 min, 20-40 min, or 40 min-1 hr. The reduced temperature exposure can be performed, for example, by blowing a cool gas on the stent or tube or by placing the stent or tube in a freezer or refrigerator. The time of exposure to reduced temperature can be less than 1 hr or less than 30 min, and more narrowly, 3-20 min, 20-40 min, or 40 min-1 hr. One cycle including both exposure to the treatment temperature and reduced temperature can be less than 20 min or less than 10 min. Treatment by temperature cycling tends to accelerate the stabilization process. Therefore, for example, temperature cycling with a total cycle time can achieve the same degree of stabilization than a single continuous exposure with a treatment time that is higher than the total cycle time. The total cycle time can be, for example, 50% or 25% of a continuous treatment time.

Increasing the temperature of the stent or tube above ambient may cause radial shrinkage (a decrease in diameter) or, in general, changes in shape such as warping along the axis of the stent or tube. This change in shape may be due to a release of residual stress that occurs during treatment. Such radial shrinkage and changes in shape are undesirable. Thus, in further embodiments, radial shrinkage or changes in shape can be reduced or prevented by restraining the stent or tube during treatment. The restraining can reduce or prevent inward radial shrinkage, warping, or both. In some embodiments, the stent or tube can be mounted over a tubular mandrel during the treatment. The mandrel can reduce or prevent inward radial shrinkage and warping of the stent or tube. The stent or tube can be loosely fitted or tightly fitted over the mandrel.

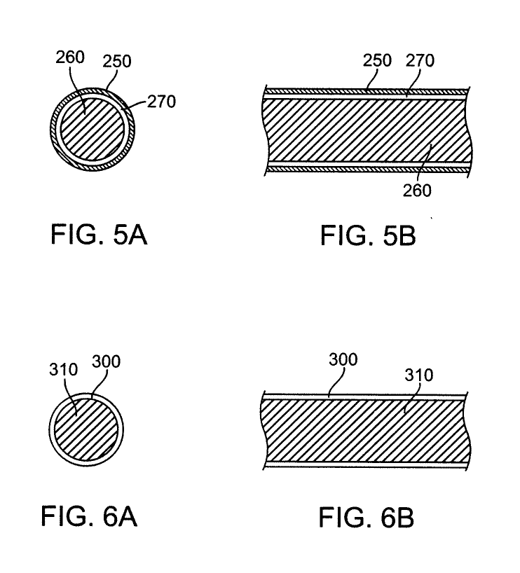

FIGS. 5A and 5B depict a tube 250 loosely fitted over a tubular mandrel 260. FIG. 5A depicts a radial cross-section and FIG. 5B depicts an axial cross-section of tube 250. The outside diameter of mandrel 260 is slightly smaller than the inside diameter of tube 250. As a result, as shown in the figures, there is a gap 270 between tube 250 and mandrel 260. As tube 250 is heated during the treatment described above, the tube may shrink slightly in the radial direction. However, mandrel 260 limits or restrains the radial shrinkage of tube 250 to the outside diameter of the mandrel.

FIGS. 6A and 6B depict a tube 300 tightly fitted over a tubular mandrel 310. FIG. 6A depicts a radial cross-section and FIG. 6B depicts an axial cross-section of tube 300. The outside diameter of mandrel 310 is the same or approximately the same (e.g., less than a 1% difference) as the inside diameter of tube 300. As a result, as shown in the figures, there is no gap between tube 300 and mandrel 310. As tube 300 is heated during the treatment described above, the tube is prevented from shrinking in the radial direction.

The heating of the stent or tube can be performed in various ways. In some of these various ways, the stent or tube can be mounted on a mandrel. In some embodiments, a stream of warm gas, such as air, argon, nitrogen, etc., at the treatment temperature can heat the stent or tube. The warm gas can be directed onto the stent or tube through a one or more nozzles. Herein a “nozzle” refers to a projecting part with an opening for regulating and directing a flow of fluid through the opening. The temperature of the gas can remain constant or it can be cycled.

In other embodiments, the stent or tube can be heated in an oven. The stent or tube can be transferred to a controlled temperature oven in which the temperature remains constant. Alternatively, the temperature in the oven can be cycled.

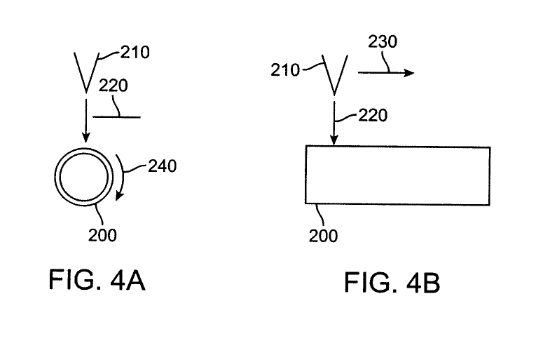

FIGS. 4A-B depict an exemplary heating process of a tube 200. FIG. 4A depicts a radial cross-section and FIG. 4B depicts an axial cross-section of tube 200. In FIGS. 4A and 4B, a nozzle 210 directs a stream of heated gas, as shown by an arrow 220. Nozzle 210 can translate along the length of tube 200 to heat the tube along its length, as shown by an arrow 230. Alternatively, the nozzle can extend along the length of tube 200. Tube 200 can rotate as shown by an arrow 240. Additionally or alternatively, the one or more additional nozzles can be positioned around tube 200, each directing a stream of heated gas at a different location of the circumference of tube 200.

The stent or tube can be cooled actively, passively, or both. In passive cooling, the stent or tube in cooled to below the treatment temperature by exposure to a lower temperature below the treatment temperature to and including ambient. For example, the stent or tube can be cooled by allowing it to cool by exposure to ambient temperature by stopping the blowing of warm air, removing it from the oven, or turning off the heating of the oven.

Alternatively, or additionally, the stent or tube can be actively cooled by exposing it to a temperature below ambient such as the subambient ranges disclosed above. For example, cool, sub-ambient temperature gas can be blown on the stent or tube or the stent or tube can be put into a sub-ambient environment such as a freezer.

In further embodiments, the treatment process of the present invention can be performed as part of the radial expansion process. In such embodiments, two heating steps of the tube may be performed instead only the one step that results in expansion of the tube. In the first step or pass of heating, as described above, the tube is heated to between Tg and Tm and the tube is expanded, followed by cooling the tube to below Tg to freeze or maintain the expanded diameter. In the second heating step, the expanded tube is heated to a temperature above ambient and below Tg, for example by blowing a warm gas on the tube, to stabilize the polymer of the tube. Temperature cycling in the stabilization step can be performed, as describe herein.

In additional embodiments, the stent can be treatment as part of or during the coating process. A coating on a stent may be formed by applying or depositing a coating composition including polymer dissolved in a solvent on the stent substrate, body, or scaffolding. The coating composition can optionally also include a therapeutic agent or drug or other substance, for example, a radiopaque agent.

The coating composition can be applied to a stent body by various methods, such as, dip coating, brushing, or spraying. In particular, spray coating a stent typically involves mounting or disposing a stent on a support, followed by spraying a coating composition from a nozzle onto the mounted stent. Solvent is removed from the deposited coating composition to form the coating. There typically is some residual solvent remaining in the coating after the solvent removal or solvent removal steps. Solvent removal can be performed by heating or exposing a coated stent to a temperature above room temperature.

A coating of a target thickness (or mass) is preferably formed with two or more cycles or passes of a coating composition application, such as spraying. After each cycle or pass, a solvent removal or drying step is performed. The solvent removal step after each pass is referred to as interpass drying. A cycle or pass refers to the application of a coating composition without an intervening solvent removal step, such as blowing warm air on the stent. In spraying, a cycle or pass can include directing the spray plume over the length of a stent one or more times. After each coating composition application pass, the application of coating composition on the substrate is stopped, which is followed by interpass solvent removal or interpass drying. Interpass drying is typically performed by directing or blowing a warm gas on the stent.

The residual solvent content in the coating after interpass drying depends on factors such the coating formulation and the boiling point of the solvent. For a PDLLA-acetone formulation, the residual solvent content may be 4-7 wt %. For other formulations that include low volatility solvents, the solvent content could be as high as 10 wt %.

Each pass results in the formation of a coating layer of a given thickness that contains a residual amount of solvent. The multiple passes result in the formation of a coating composed of multiple layers, the combined thickness of the multiple layers being the target thickness of the coating. Any suitable number of repetitions of applying the composition followed by removing the solvent(s) can be performed to form a coating of a desired thickness or mass. Excessive application of the polymer can, however, cause coating defects.

When a coating of a target thickness or mass is obtained, residual solvent can be removed by baking the coated stent in a controlled temperature oven, as mentioned above. Thus, the heat treatment of the present invention can be performed during the interpass drying or during the oven baking step of the coating process. The interpass drying, baking, or both can be performed at the temperature ranges, treatment times, as described above. Temperature cycling at interpass drying or baking can also be performed.

### Experimental Quantification of Densification During Aging

Time-dependent volumetric shrinkage in a polymer due to physical aging can be measured directly using a density gradient column. Such experiments are difficult to perform due to the precision required. However, the density of polymers can be measured by electrical densimeters, for example, the Densimeter SD-200L made by Qualitest of Fort Lauderdale, Fla.

The physical aging process is associated with enthalpy relaxation and can be characterized with differential scanning calorimetry (DSC) by the excess endothermic relaxation peak (excess enthalpy) that occurs near Tg. Therefore, the extent of physical aging can be measured by characterizing the excess enthalpy using DSC. Excess enthalpy is analyzed from the extra peak area above the base thermogram of a non aged (or second heated) sample near glass transition temperature.

In addition, the effect on mechanical properties of densification can be measured. This includes modulus, radial strength, post dilatation deployment to fracture, and recoil.

The “glass transition temperature,” Tg, is the temperature at which the amorphous domains of a polymer change from a brittle vitreous state to a solid deformable or ductile state at atmospheric pressure. In other words, the Tg corresponds to the temperature where the onset of segmental motion in the chains of the polymer occurs. Tg of a given polymer can be dependent on the heating rate and can be influenced by the thermal history of the polymer. Furthermore, the chemical structure of the polymer heavily influences the glass transition by affecting mobility.

“Stress” refers to force per unit area, as in the force acting through a small area within a plane. Stress can be divided into components, normal and parallel to the plane, called normal stress and shear stress, respectively. True stress denotes the stress where force and area are measured at the same time. Conventional stress, as applied to tension and compression tests, is force divided by the original gauge length.

“Strength” refers to the maximum stress along an axis which a material will withstand prior to fracture. The ultimate strength is calculated from the maximum load applied during the test divided by the original cross-sectional area.

“Modulus” may be defined as the ratio of a component of stress or force per unit area applied to a material divided by the strain along an axis of applied force that results from the applied force. The modulus is the initial slope of a stress-strain curve, and therefore, determined by the linear hookean region of the curve. For example, a material has both a tensile and a compressive modulus. A material with a relatively high modulus tends to be stiff or rigid. Conversely, a material with a relatively low modulus tends to be flexible. The modulus of a material depends on the molecular composition and structure, temperature of the material, amount of deformation, and the strain rate or rate of deformation. For example, below their Tg, many polymers tend to be brittle with a high modulus. As the temperature of a polymer is increased from below to above its Tg, its modulus decreases.

“Strain” refers to the amount of elongation or compression that occurs in a material at a given stress or load.

“Elongation” may be defined as the increase in length in a material which occurs when subjected to stress. It is typically expressed as a percentage of the original length.

Elongation to Break is the strain on a sample when it breaks. It is usually is expressed as a percent.

“Toughness” is the amount of energy absorbed prior to fracture, or equivalently, the amount of work required to fracture a material. One measure of toughness is the area under a stress-strain curve from zero strain to the strain at fracture. The stress is proportional to the tensile force on the material and the strain is proportional to its length. The area under the curve then is proportional to the integral of the force over the distance the polymer stretches before breaking. This integral is the work (energy) required to break the sample. The toughness is a measure of the energy a sample can absorb before it breaks. There is a difference between toughness and strength. A material that is strong, but not tough is said to be brittle. Brittle substances are strong, but cannot deform very much before breaking.

“Solvent” is defined as a substance capable of dissolving or dispersing one or more other substances or capable of at least partially dissolving or dispersing the substance(s) to form a uniformly dispersed solution at the molecular- or ionic-size level at a selected temperature and pressure. The solvent should be capable of dissolving at least 0.1 mg of the polymer in 1 ml of the solvent, and more narrowly 0.5 mg in 1 ml at the selected temperature and pressure, for example, ambient temperature and ambient pressure.

While particular embodiments of the present invention have been shown and described, it will be obvious to those skilled in the art that changes and modifications can be made without departing from this invention in its broader aspects. Therefore, the appended claims are to encompass within their scope all such changes and modifications as fall within the true spirit and scope of this invention.

What is claimed is:

1. A method for reducing long term aging of stent, comprising:
providing a polymeric tube, the polymer having a Tg above ambient temperature;
radially expanding the tube at a temperature above the Tg of the polymer;
cooling the expanded tube to a temperature below the Tg of the polymer which maintains the tube at an expanded diameter; and
heating the expanded tube to a temperature range between room temperature and the Tg of the polymer and maintaining the temperature range for a treatment time, wherein the increase in temperature increases the density of the polymer;
cooling the tube after the treatment time to ambient temperature; and
making a stent from the cooled tube.

2. The method of claim 1, wherein the polymer is poly(L-lactide).

3. The method of claim 3, wherein temperature range is 35-55° C.

4. The method of claim 1, wherein the treatment time is 3 min-24 hrs.

5. The method of claim 1, further comprising restraining the tube to prevent radial shrinkage during the treatment time.

6. A method of making a stent, comprising:
radially expanding a polymeric tube at a temperature above the Tg of the polymer, the polymer having a Tg above room temperature;
cooling the expanded tube to a temperature below the Tg of the polymer which maintains the tube at an expanded diameter;
making a stent body from the cooled, expanded tube;
heating the stent body to a temperature range between ambient temperature and the Tg of the polymer before coating, crimping, or sterilizing the stent body,
maintaining the temperature range for a treatment time,
wherein the increase in temperature increases the density of the polymeric stent body; and
cooling the stent body to ambient temperature.

7. The method of claim 6, wherein the polymer is poly(L-lactide).

8. The method of claim 7, wherein temperature range is 35-55° C.

9. The method of claim 6, further comprising restraining the tube to prevent radial shrinkage during the treatment time.

10. The method of claim 6, wherein the treatment time is 0.3-24 hrs.

11. The method of claim 6, wherein the stent body is heated after the stent is coated and the heating step removes residual solvent from the coating.

12. A method reducing long term aging of stent, comprising:
heating a polymeric stent body or polymeric tube to a temperature range between ambient temperature and a Tg of the polymer,
wherein the Tg of the polymer is greater than room temperature;
cooling the stent body or polymeric tube to at most the ambient temperature;
repeating the heating and cooling steps at least one time; and
if a polymeric tube, making a stent body from the polymeric tube.

13. The method of claim 12, wherein the stent body or polymeric tube are cooled to below ambient temperature.

14. The method of claim 12, further comprising restraining the stent body or polymer tube to prevent radial shrinkage during while the stent is above ambient temperature.

15. The method of claim 12, wherein the polymer is poly(L-lactide).

16. The method of claim 15, wherein temperature range is 35-55° C.

17. The method of claim 12, wherein the repeated heating and cooling achieves a degree of stabilization faster than a single continuous exposure.
